(19) United States
(12) Patent Application Publication
(10) Pub. No.: US 2014/0181799 A1
(43) Pub. Date: Jun. 26, 2014

(54) Boot Bank Selection, Bios, Upgrades and Crisis Recovery In Intel Based Platforms

(71) Applicant: EMERSON NETWORK POWER-EMBEDDED COMPUTING, INC., Tempe, AZ (US)

(72) Inventors: Rajesh MANGAL, Gilbert, AZ (US); Malcolm J. RUSH, Phoenix, AZ (US); Richard D. SMITH, Phoenix, AZ (US); James HOLBROOK, Tempe, AZ (US)

(73) Assignee: EMERSON NETWORK POWER - EMBEDDED COMPUTING, INC., Tempe, AZ (US)

(21) Appl. No.: 13/796,355

(22) Filed: Mar. 12, 2013

Related U.S. Application Data
(60) Provisional application No. 61/745,054, filed on Dec. 21, 2012.

(51) Int. Cl. G06F 9/445

(52) U.S. Cl. CPC G06F 8/665
USPC 717/168

(57) ABSTRACT

A firmware upgrade computer system includes a bank select switch that generates a bank select signal. The system further includes a bank module that includes a first firmware code and a second bank module that includes a second firmware code. The system also includes a control module that determines whether the first bank module and the second bank module is a selected bank based on the bank select signal. The control module determines whether the first bank module and the second bank module is a nonselected bank based on the bank select signal. The control module selectively instructs the selected bank to communicate one of the first firmware code and the second firmware code to the nonselected bank. The system also includes a storage module that stores a selected bank value indicative of the selected bank.

### CROSS-REFERENCE TO RELATED APPLICATIONS

This application claims the benefit of U.S. Provisional Application No. 61/745,054, filed on Dec. 21, 2012. The entire disclosure of the above application is incorporated herein by reference.

### FIELD

The present disclosure relates to upgrading the firmware of a circuit board.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Computer systems may include one or more printed circuit boards (PCBs). Each of the PCBs may include a plurality of modules controlled by firmware stored in non-volatile memory, such as flash memory. For example, a PCB may have a peripheral module that receives commands from the firmware. Further, the PCB may include a processor. The processor may execute code stored in the flash memory.

### SUMMARY

A firmware upgrade computer system includes a bank select switch that generates a bank select signal. The system further includes a bank module that includes a first firmware code and a second bank module that includes a second firmware code. The system also includes a control module that determines whether the first bank module and the second bank module is a selected bank based on the bank select signal. The control module determines whether the first bank module and the second bank module is a nonselected bank based on the bank select signal. The control module selectively instructs the selected bank to communicate one of the first firmware code and the second firmware code to the nonselected bank. The system also includes a storage module that stores a selected bank value indicative of the selected bank.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a computer system including a firmware upgrade and recovery system according to the present disclosure;

FIG. 2 is a functional block diagram of a logic module according to the present disclosure;

FIG. 3 is a flow diagram illustrating a firmware upgrade method according to the present disclosure;

FIG. 4 is a flow diagram illustrating a firmware upgrade failure recovery method according to the present disclosure; and

FIG. 5 is a flow diagram illustrating a crisis recovery method according to the present disclosure.

### DETAILED DESCRIPTION

Computer systems may include one or more printed circuit boards (PCBs). Each of the PCBs may include a plurality of modules controlled according to firmware stored in memory (e.g., flash memory). A processor executing the firmware may control operations of the modules. For example, the firmware may direct a module of a PCB to execute code within the module. Computer systems may periodically require a firmware upgrade. For example, the PCB may receive a firmware upgrade in order for the PCB to perform according to the firmware upgrade. An attempted firmware upgrade may require a firmware recovery if the attempted firmware upgrade is unsuccessful.

A logic module according to the principles of the present disclosure is arranged to execute firmware upgrades and firmware recoveries of the PCB. The logic module may execute the firmware upgrade based on a plurality of signals. The logic module may also determine whether a firmware recovery is required. The logical module may execute code to restore previously installed firmware.

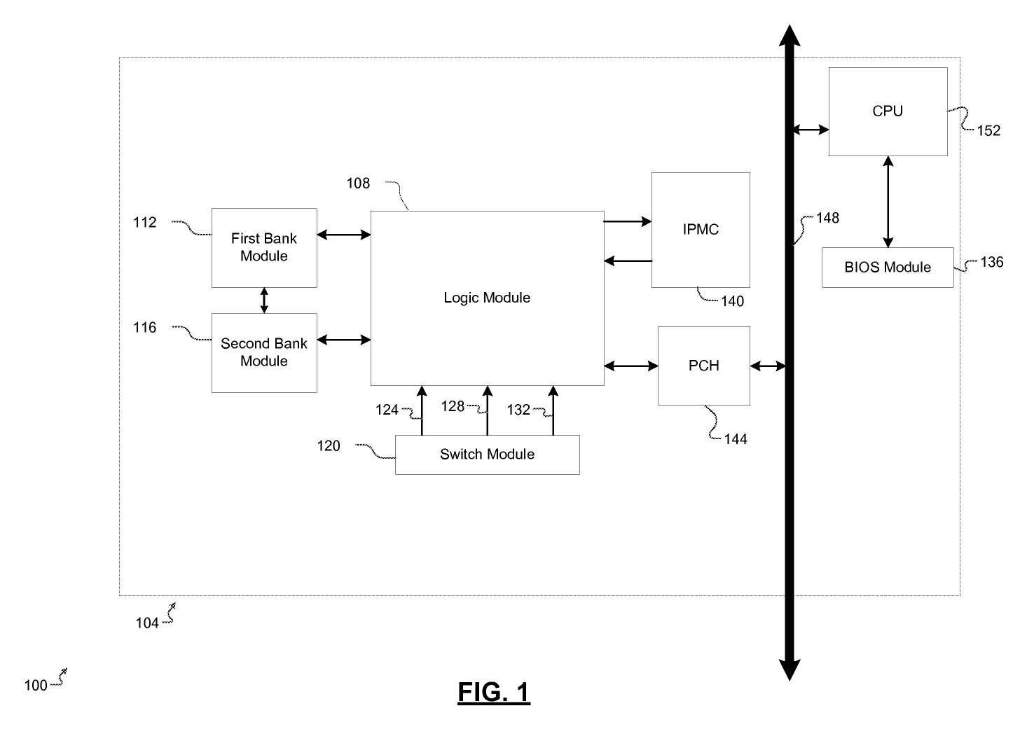

Referring now to FIG. 1, an example computer system 100 including a printed circuit board (PCB) 104 and a logic module 108 is shown. For example only, the logic module 108 may include a complex programmable logic device. The logic module 108 communicates with a first bank module 112 and a second bank module 116. The first bank module 112 and the second bank module 116 may be non-volatile memory, such as flash memory. The first bank module 112 and the second bank module 116 are electrically coupled to the PCB 104. The first bank module 112 and the second bank module 116 may include code and/or data stored in the first bank module 112 or the second back module 116. The logic module 108 may select the first bank module 112 and the second bank module 116 in order to execute code stored in the first bank module 112 and the second bank module 116. For example, the logic module 108 sends a signal to the first bank module 112 indicating the first bank module 112 is a selected bank. The logic module 108 may select the first bank module 112 while performing a firmware upgrade.

The logic module 108 communicates with a switch module 120. The switch module 120 may include a plurality of switches, including, but not limited to, a bank select switch, a bank select enable switch, and a management engine (ME) inhibit switch. The switch module 120 may communicate a plurality of signals to the logic module 108. The plurality of signals may include a bank select enable signal 124, a bank select signal 128, and an ME inhibit signal 132. For example, the logic module 108 receives a bank select enable signal 124 indicating the switch module 120 is enabled to communicate a selected bank to the logic module 108. The logic module 108 also receives a bank select signal 128. The bank select signal 128 communicates to the logic module 108 that one of the first bank module 112 or the second bank module 116 is a selected bank. For example, an operator of the PCB 104 may actuate the bank select switch within the switch module 120. The bank select switch may be an electrical switch or a toggle switch.

The bank select switch indicates a selected bank. For example, the selected bank may include executable code. The selected bank may be selected in order to execute the executable code. When the bank select switch is actuated to a first position, the first bank module 112 is the selected bank. When the bank select switch is actuated to a second position, the second bank module 116 is the selected bank. The switch module 120 generates the bank select signal based on a bank select switch position. The switch module 120 communicates the bank select signal 128 to the logic module 108. The logic module 108 determines whether the first bank module 112 or the second bank module 116 is the selected bank based on the bank select signal.

The logic module 108 may receive an ME inhibit signal 132 to enable ME inhibition. For example, the operator of the PCB 104 may actuate the ME inhibit switch within the switch module 120. The ME inhibit switch may be an electrical switch or a toggle switch. When the ME inhibit switch is actuated to a first position, ME inhibition is enabled. When the ME inhibit switch is actuated to a second position, ME inhibition is disabled. The switch module 120 generates an ME inhibition signal based on an ME inhibit switch position. The switch module 120 communicates the ME inhibition signal to the logic module 108. The logic module 108 determines whether to enable ME inhibition based on the ME inhibition signal. For example, the logic module 108 enables ME inhibition prior to executing a firmware upgrade on the computer system 100 to disable ME firmware execution to the computer system 100. By disabling ME firmware execution, the first bank module 112 and the second bank module 116 are write protected during a firmware upgrade.

The PCB 104 may also include a BIOS module 136. The BIOS module 136 may control bank selection of the PCB 104. For example, the BIOS module 136 controls the bank selection of the PCB 104 if the PCB 104 was booted from at least one of the first bank module 112 and the second bank module 116. The BIOS module 136 communicates a selected bank to the logic module 108 by overriding the switch module 120.

The PCB 104 may also include an intelligent platform management controller (IPMC) 140. The IPMC 140 communicates a selected bank to the logic control module 108 through an I/O line. The IPMC 140 may be enabled to select at least one of the first bank module 1112 and the second bank module 116. For example, the IPMC 140 may be enabled to select a bank if the bank select enable switch is actuated to the on position. When the bank select enable switch is on, the switch module 120 sends a bank select enable signal 124 to the logic module 108 indicating the IPMC 140 is enabled. The IPMC 140 may also receive a current bank select status from the logic module 108. Further, the BIOS module 136 may prevent the IPMC 140 from controlling the first bank module 112 and the second bank module 116. For example, when the BIOS module 136 is enabled to control bank selection of the PCB 104, the BIOS 136 prevents the IPMC 140 from controlling bank selection of the PCB 104.

The logic module 108 also communicates with a peripheral controller hub (PCH) 144 and a bus 148. The logic module 108 also communicates with a central processing unit (CPU) 152 through the PCH 144. The CPU 152 may selectively execute code stored in one of the first bank module 112 and the second bank module 116 based on an instruction from the logic module 108.

In some embodiments, the logic module 108 may perform a firmware upgrade of the PCB 104. For example, the logic module 108 receives a bank select signal 128. The bank select signal 128 indicates that one of the first bank module 112 and the second bank module 116 is a selected bank. For example, the bank select signal 128 may indicate the first bank module 112 is the selected bank. The logic module 108 then determines whether the first bank module 112 includes a firmware upgrade code. When the logic module 108 determines the first bank module 112 includes firmware upgrade code, the logic module 108 selects the second bank module 116 to receive the firmware upgrade code. The logic module 108 instructs the CPU 152 to execute the firmware upgrade code. When the CPU 152 executes the firmware upgrade code, the firmware upgrade code installs a firmware on the second bank module 116.

The logic module 108 may also perform a firmware upgrade recovery of the PCB 104. For example, the logic module 108 determines whether a previously performed firmware upgrade does not correlate to a predetermined expected result. The logic module 108 determines which of the first bank module 112 or the second bank module 116 includes the firmware upgrade code. When the logic module 108 determines the first bank module 112 includes the firmware upgrade code, the logic module 108 selects the first bank module 112 as a selected bank. The logic module 108 may instruct the PCB 104 to reboot from the selected bank. The PCB 104 operates according to the firmware upgrade code in the first bank module 112.

The logic module 108 may also perform a crisis recovery of the PCB 104. For example, the logic module 108 determines that one of the first bank module 112 and the second bank module 116 includes corrupted code. For example, the second bank module 116 may include code that includes corrupted data. The logic module 108 selects the first bank module 112 as the selected bank. The logic module 108 instructs the PCB 104 to reboot from the selected bank. The PCB 104 operates according to code in the first bank module 112.

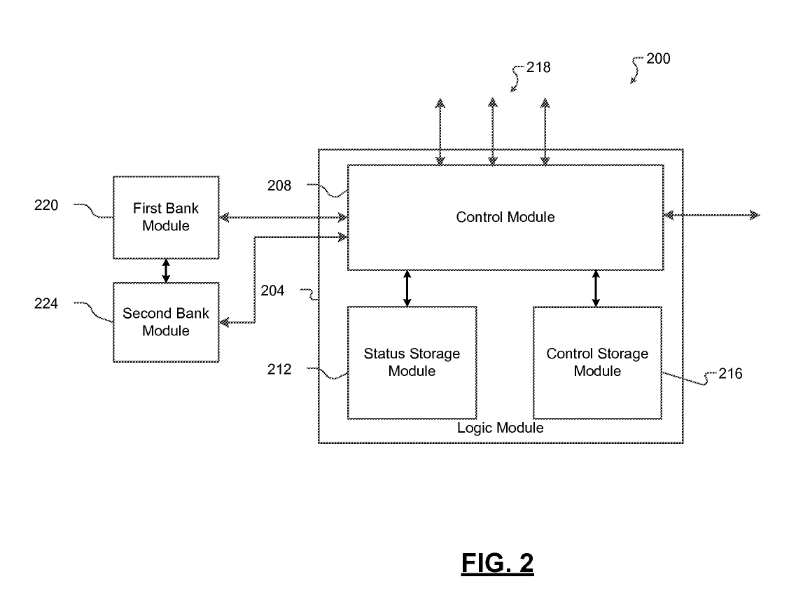

Referring now to FIG. 2, a firmware upgrade and recovery system 200 includes an example logic module 204. The logic module 204 includes a control module 208, a status storage module 212, and a control storage module 216. The firmware upgrade and recovery system 200 also includes a plurality of signals 218, a first bank module 220, and a second bank module 224. The control module 208 may receive the plurality of signals 218 (as illustrated in FIG. 1). For example, the control module 208 may receive a bank select signal 128 (FIG. 1). The bank select signal 128 is indicative of a selected bank. The control module 208 determines which of the first bank module 220 and the second bank module 224 is the selected bank based on the bank select signal 128. The control module 208 communicates the selected bank to the status storage module 212. The status storage module 212 stores a status indicative of the selected bank. For example, the status storage module 212 stores a status indicating the first bank module 220 is the selected bank.

The control module 208 also controls access to the first bank module 220 and the second bank module 224. For example, the control module 208 receives a software bank select override signal from the plurality of signals 218. The software bank select override signal indicates that software, such as BIOS, may override one of a plurality of switch signals (as illustrated in FIG. 1). The control module 208 communicates the software bank select override signal to the control storage module 216. The control storage module 216 stores a status indicative of the software bank select override signal. The control module 208 allows software, such as the BIOS, to access the first bank module 220 and the second bank module 224. For example, the control module 208 may allow the BIOS to access the first bank module 220 in order to perform a firmware upgrade.

The control module 208 may perform a firmware upgrade of one of the first bank module 220 and the second bank module 224. For example, the control module 208 receives the plurality of signals 218. The plurality of signals 218 may include a bank select signal, for example, the bank select signal 128. The bank select signal 128 indicates which of the first bank module 220 and the second bank module 224 is the selected bank. The selected bank is a bank that includes a firmware upgrade code. For example, the first bank module 220 may include the firmware upgrade code.

The control module 208 instructs the PCB 104 (as illustrated in FIG. 1) to reboot from the first bank module 220. The control module 208 receives a bank select override signal from the plurality of signals 218. The bank select override signal indicates that one of first bank module 220 and second bank module 224 is a bank to receive the firmware upgrade code. For example, the bank select override signal may indicate that the second bank module 224 is selected to receive the firmware upgrade code. The control module 208 communicates that the second bank module 224 is selected to receive the firmware upgrade code to the statues storage module 212. The statues storage module 212 stores a status indicative of the second bank module 224 is selected to receive the firmware upgrade code.

The control module 208 may prevent the IPMC 140 (as described in FIG. 1) from accessing a bank selected to receive the firmware upgrade code during performance of the firmware upgrade. For example, the control module 208 prevents the IPMC 140 from accessing the second bank module 224 during the firmware upgrade. The control module 208 enables a timer within the IPMC 140. When an operator of the PCB 104 is not present at the PCB 104, the control module 208 enables the timer within the IPMC 140 to prevent the IPMC 140 from accessing the second bank module 224 during the firmware upgrade.

When the timer expires, the IPMC 140 is arranged to determine whether the bank selected to receive the firmware upgrade code received the firmware upgrade code. When the IPMC 140 determines the bank selected to receive the firmware upgrade code did not receive the firmware upgrade code, the IPMC 140 instructs the PCB 104 to boot from the selected bank. For example, when the IPMC 140 determines the second bank module 224 did not receive the firmware upgrade code, the IPMC 140 instructs the PCB 104 to boot from the first bank module 220. The PCB 104 operates according to code in the first bank module 220.

In another example, the control module 208 may inhibit ME (as described in FIG. 1) during a firmware upgrade. For example, the control module 208 inhibits ME to prevent ME access to the PCB 104. The control module 208 may communicate to the BIOS to inhibit ME. In another example, the control module 208 receives a signal from the plurality of signals 218 indicative of ME inhibition. The control module communicates to the status storage module 212 that ME is inhibited. The status storage module 212 stores a status indicative of ME inhibition.

In another example, the control module 208 may perform a crisis recovery of the PCB 104. The control module 208 receives the plurality of signals 218. For example, the control module 208 may receive the bank select signal 128. The bank select signal 128 is indicative of a selected bank. For example, the control module 208 receives the bank select signal selecting one of the first bank module 220 and the second bank module 224 as the selected bank. The control module 208 communicates the selected bank to the status storage module 212. The status storage module 212 stores a status indicative of the selected bank.

The control module 208 may prevent IPMC 140 from accessing the selected bank. For example, the control module 208 prevents IPMC 140 from accessing the first bank module 224. The control module 208 disables a timer within IPMC 140. For example, if a user is not present at the PCB 104, the control module 208 disables the timer within IPMC 140 to prevent automatic recovery of the selected bank. In another embodiment, the control module 208 may recover a failed firmware upgrade automatically. For example, the control module 208 allows the IPMC to control the first bank module 112 and the second bank module 116 by setting the bank enable switch to on. An operator of the PCB 104 enables a timer within the IPMC 140. If the PCB 104 does not reboot after an attempt to upgrade the firmware, the timer will expire and the IPMC 140 will select a known good bank and reboot.

The control module 208 may inhibit ME. For example, the control module 208 communicates to the BIOS to inhibit ME. In another example, the control module 208 may receive a signal indicative of ME inhibition from the plurality of signals 218. The control module communicates to the status storage module 212 that ME is inhibited. The status storage module 212 stores a status indicative of ME inhibition.

The control module 208 may perform the crisis recovery of the selected bank. The control module 208 executes code stored within the control module 208 to perform the crisis recover of the selected bank. The control module 208 determines whether the selected bank received the code stored within the control module 208. When the control module 208 determines the selected bank received the code stored within the control module 208, the control module 208 communicates the selected bank to the status storage module 212. The status storage module 212 may store a status indicative of the selected bank. The control module 208 instructs the PCB 104 to boot from the selected bank. The PCB 104 determines which of the first bank module 220 and the second bank module 224 is the selected bank based on the stored status. The PCB 104 boots from the selected bank. The PCB 104 operates according to code stored in the selected bank.

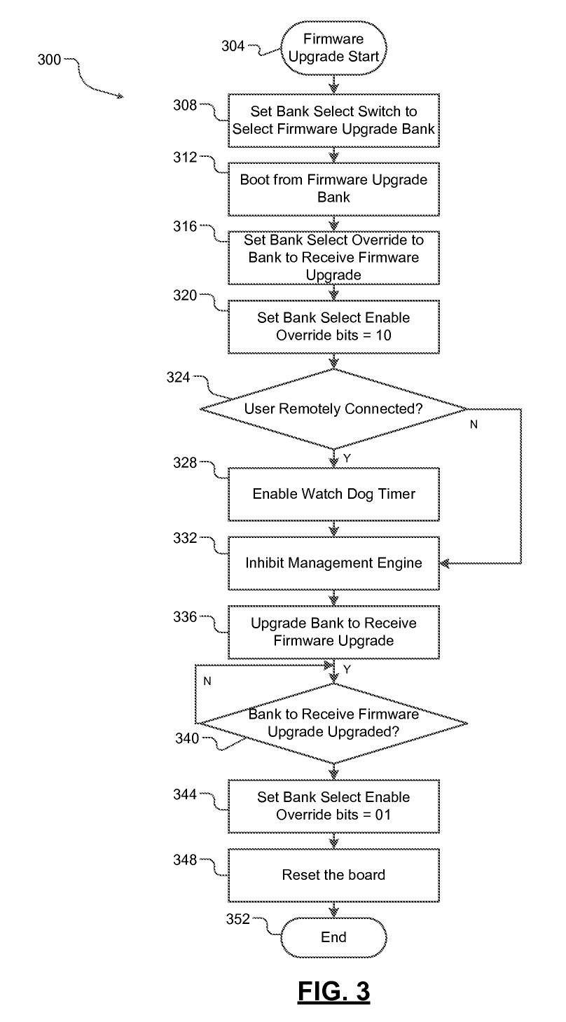

Referring now to FIG. 3, a firmware upgrade method 300 begins at 304. At 308, the method 300 sets a bank select switch to select a firmware upgrade bank. At 312, the method 300 boots from the firmware upgrade bank. At 316, the method 300 sets a bank select override to a bank to receive the firmware upgrade. At 320, the method 300 sets a bank select enable override bits to 10. At 324, the method 300 determines whether a user is remotely connected. If false, the method 300 continues to 332. If true, the method continues to 328. At 328, the method 300 enables a watch dog timer. At 332, the method 300 inhibits a management engine. At 336, the method 300 upgrades the bank to receive the firmware upgrade. At 340, the method 300 determines whether the bank to receive the firmware upgrade has been upgraded. If false, the method 300 continues at 340. If true, the method 300 continues to 344. At 344, the method 300 sets the bank select enable override bits to 01. At 348, the method 300 resets the board. The method 300 ends at 352.

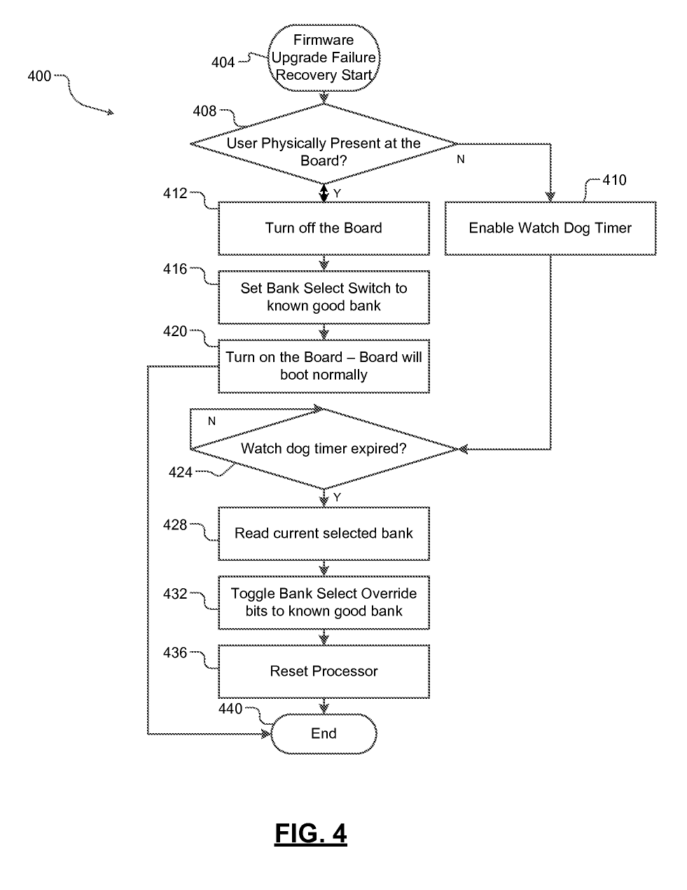

Referring now to FIG. 4, a firmware upgrade failure recovery method 400 starts at 404. At 408, the method 400 determines if the user is physically present at the board. If false, the method 400 continues at 410. If true, the method 400 continues at 412. At 412, the method 400 turns off the board. At 416, the method 400 sets the bank select switch to a known good bank. At 420, the method 400 turns the board on. The method 400 ends at 440. At 410, the method 400 enables a watch dog timer. At 424, the method 400 determines whether the watch dog timer has expired. If false, the method 400 continues at 424. If true, the method 400 continues to 428. At 428, the method 400 reads the current selected bank. At 432, the method 400 toggles the bank select override bits to the known good bank. At 436, the method 400 resets the processor. The method 400 ends at 440.

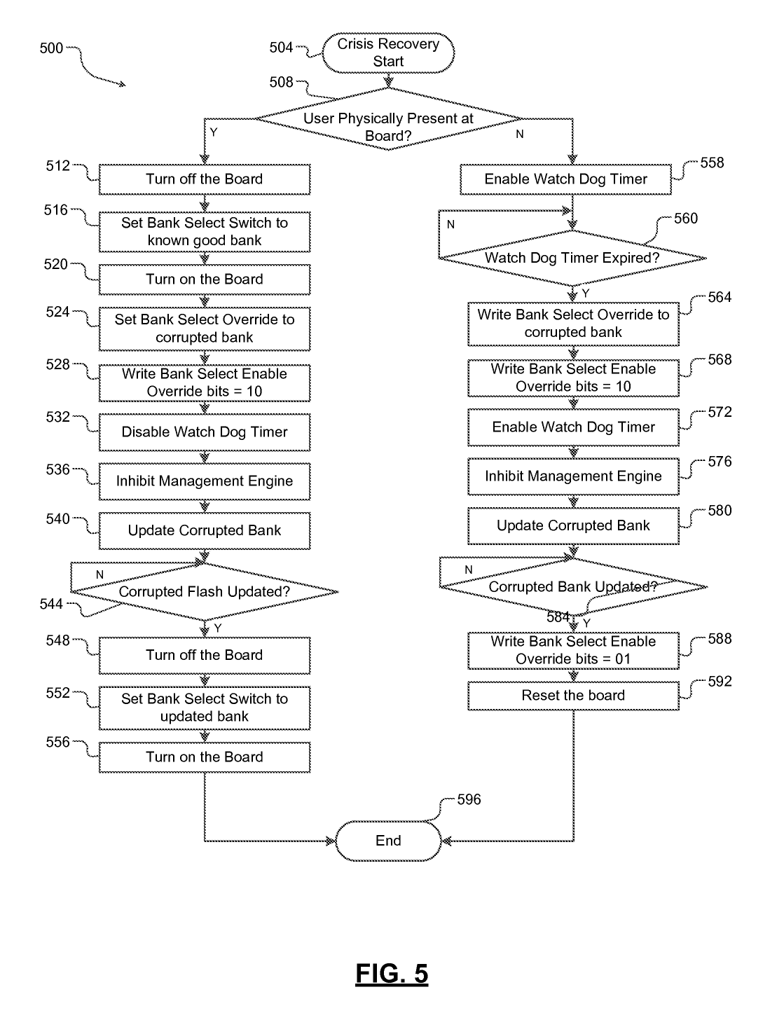

Referring now to FIG. 5, a crisis recovery method 500 starts at 504. At 508, the method 500 determines whether the user is physically present at the board. If false, the method 500 continues at 558. If true, the method 500 continues at 512. At 512, the method 500 turns off the board. At 516, the method 500 sets the bank select switch to a known good bank. At 520, the method 500 turns the board on. At 524, the method 500 sets the bank select override to a corrupted bank. At 528, the method 500 writes the bank selected enable override bits to 10. At 532, the method 500 disables the watch dog timer. At 536, the method 500 inhibits the management engine. At 540, the method 500 updates the corrupted bank. At 544, the method 500 determines whether the corrupted bank has been updated. If false, the method 500 continues at 544. If true, the method 500 continues at 548. At 584, the method 500 turns off the board. At 552, the method 500 sets the bank select switch to the updated bank. At 556, the method 500 turns on the board. The method 500 ends at 596.

At 558, the method 400 enables a watch dog timer. At 560, the method 500 determines whether the watch dog timer has expired. If false, the method 500 continues at 560. If true, the method 500 continues at 564. At 564, the method 500 writes the bank select override to a corrupted bank. At 568, the method 500 writes the bank select enable override bits to 10. At 572, the method 500 enables the watch dog timer. At 576, the method 500 inhibits the management engine. At 580, the method 500 updates the corrupted bank. At 584, the method 500 determines whether the corrupted bank has been updated. If false, the method 500 continues at 584. If true, the method 500 continues at 588. At 588, the method 500 writes the bank select enable override bits to 01. At 592, the method 500 resets the board. The method 500 ends at 596.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A firmware upgrade computer system comprising:
a bank select switch that generates a bank select signal;
a first bank module that includes a first firmware code and a second bank module that includes a second firmware code;
a control module that determines whether the first bank module and the second bank module is a selected bank based on the bank select signal and determines whether the first bank module and the second bank module is a nonselected bank based on the bank select signal and selectively instructs the selected bank to communicate one of the first firmware code and the second firmware code to the nonselected bank; and
a storage module that stores a selected bank value indicative of the selected bank.

2. The system of claim 1 wherein the control module determines the first bank module is the selected bank based on the bank select signal.

3. The system of claim 2 wherein the control module selectively instructs the first bank module to communicate the first firmware code to the second bank module.

4. The system of claim 1 further comprising the control module determines whether the nonselected bank received the one of the first firmware code and the second firmware code.

5. The system of claim 4 wherein the control module determines the selected bank based on the selected bank value and boots the computer system from the selected bank based on the determines whether the nonselected bank received the one of the first firmware code and the second firmware code.

6. The system of claim 1 wherein the control module determines whether the nonselected bank includes corrupted firmware code.

7. The system of claim 6 wherein the control module determines the selected bank based on the selected bank value and boots the computer system from the selected bank based on the determines whether the nonselected bank includes corrupted firmware code.

8. The system of claim 1 further comprising a bank select software override switch that generates a software override signal and a BIOS that generates a software bank select signal based on the software override signal.

9. The system of claim 8 wherein the control module determines whether the first bank module and the second bank module is a selected bank based on the software bank select signal and determines whether the first bank module and the second bank module is a nonselected bank based on the software bank select signal and selectively instructs the selected bank to communicate one of the first firmware code and the second firmware code to the nonselected bank.

10. A method for upgrading firmware of a computer system comprising:
generating a bank select signal;
a first bank module that includes a first firmware code and a second bank module that includes a second firmware code;
determining whether the first bank module and the second bank module is a selected bank based on the bank select signal and determining whether the first bank module and the second bank module is a nonselected bank based on the bank select signal and selectively instructing the selected bank to communicate the first firmware code and the second firmware code to the nonselected bank; and
storing a selected bank value based indicative of the selected bank.

11. The method of claim 10 further comprising determining the first bank module is the selected bank based on the bank select signal.

12. The method of claim 11 further comprising selectively instructing the first bank module to communicate the first firmware code to the second bank module.

13. The method of claim 10 further comprising determining whether the nonselected bank received the one of the first firmware code and the second firmware code.

14. The method of claim 13 further comprising determining the selected bank based on the selected bank value and booting the computer system from the selected bank based on the determining whether the nonselected bank received the one of the first firmware code and the second firmware code.

15. The method of claim 10 further comprising determining whether the nonselected bank includes corrupted firmware code.

16. The method of claim 15 further comprising determining the selected bank based on the selected bank value and booting the computer system from the selected bank based on the determining whether the nonselected bank includes corrupted code.

17. The method of claim 10 further comprising generating a software override signal and generating a software bank select signal based on the software override signal.

18. The method of claim 17 further comprising determining whether the first bank module and the second bank module is a selected bank based on the software bank select signal and determining whether the first bank module and the second bank module is a nonselected bank based on the software bank select signal and selectively instructing the selected bank to communicate one of the first firmware code and the second firmware code to the nonselected bank.
